(19) United States
(12) Patent Application Publication
(10) Pub. No.: US 2004/0129760 A1
(43) Pub. Date: Jul. 8, 2004

(54) Apparatus for transferring a wafer

(76) Inventors: Chi-meng Shen, Taoyuan (TW); Charlie C. Chen, Taoyuan (TW); Yao-chi Fei, Taoyuan (TW); Chih-hsien Cheng, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/394,535

(22) Filed: Mar. 21, 2003

(30) Foreign Application Priority Data
Jan. 2, 2003 (TW) 92100075

(51) Int. Cl. B23K 31/02

(52) U.S. Cl. 228/103; 228/245; 228/223; 228/33; 228/41

(57) ABSTRACT

A wafer transfer apparatus adapted to a wafer ball placement apparatus including at least one wafer cassette, a flux dispenser unit, a ball placement unit, a reflow oven unit, and an unloader. The apparatus is also adapted to a wafer bump printing apparatus including at least one wafer cassette, a bump printing unit, a reflow oven unit, and an unloader. The apparatus includes a robot arm for picking up a wafer from the at least one wafer cassette and transferring the wafer to/from one of the wafer cassette, the flux dispenser unit, the ball placement unit or bump printing unit, and the reflow oven unit. The apparatus may also include a stage for carrying and moving the robot arm. With the apparatus, it is possible to reduce process time, simplify steps of transferring the wafer and lower risks of breaking wafer. The invention can achieve the effects of improving the production efficiency, saving the space and simplifying the apparatus.

### BACKGROUND OF THE INVENTION

1. Field of the Invention

The invention relates to an apparatus for transferring a wafer, and more particularly to a wafer transfer apparatus and method adapted in a wafer ball placement/bump printing apparatus to simplify the manufacturing processes. Concretely speaking, the apparatus and method may shorten the time for the wafer ball placement/bump printing process, simplify the steps for transferring the wafers, and lower the possibility of wafer breaking during the wafer transfer process so as to increase the production efficiency and save the space and apparatus.

2. Description of the Related Art

During the semiconductor manufacturing processes, wafer solder bumps are formed in two methods. The first method includes the steps of applying flux to a wafer, placing tin balls on the wafer, and then forming solder bumps on the wafer by way of heating and reflowing. The second method includes the steps of printing solder paste on a wafer and then forming solder bumps on the wafer by way of heating and reflowing. Each of the above-mentioned methods further includes an inspection step for inspecting the quality of the wafer bumps after the ball placement/bump printing steps.

FIG. 1A is a schematic illustration showing a conventional wafer ball placement apparatus. Referring to FIG. 1A, the wafer ball placement apparatus includes a flux dispenser device 11, a ball placement device 12, an inspection device 13, and a reflow oven device 14. The flux dispenser device 11 includes a loader/unloader 111 and a flux dispenser unit 112. The ball placement device 12 includes a loader/unloader 111 and a ball placement unit 122. The inspection device 13 includes a loader/unloader 111 and an inspection unit 132. The reflow oven device 14 includes a loader/unloader 111 and a reflow oven unit 142.

FIG. 1B is a schematic illustration showing a conventional wafer bump printing apparatus. Referring to FIG. 1B, the wafer bump printing apparatus includes a bump printing device 15, an inspection device 13, and a reflow oven device 14. The bump printing device 15 includes a loader/unloader 111 and a bump printing unit 152. The inspection device 13 includes a loader/unloader 111 and an inspection unit 132. The reflow oven device 14 includes a loader/unloader 111 and a reflow oven unit 142.

In the above-mentioned wafer ball placement/bump printing process, a wafer cassette is utilized to carry a wafer or a plurality of wafers. Then, the cassette is artificially transferred or automatically transferred, by an automatic transfer apparatus, between the above-mentioned devices, and the wafer(s) may be loaded to/unloaded from the devices by the loader/unloader.

Conventionally, the wafer cassette carrying a wafer or a plurality of wafers is artificially transferred or automatically transferred by an automatic transfer apparatus. When the cassette is transferred to each device, a step for loading/unloading the wafer(s) has to be performed. Hence, the processing time is wasted and the repeated steps may further increase the possibility of wafer breaking. So, the conventional method is disadvantageous to the production efficiency. On the other hand, the individual devices may also cause the problems of space wasting and repeated investments for the apparatus.

Consequently, it is an important subject of the invention to shorten the processing time, decrease the possibility of wafer breaking, increase the production efficiency, and save space and apparatus.

### SUMMARY OF THE INVENTION

In view of the above-mentioned problems, it is therefore an object of the invention to provide a wafer transfer apparatus capable of saving processing time, simplifying manufacturing steps, decreasing the possibility of wafer breaking, increasing the production efficiency, and saving space and apparatus.

The invention provides a wafer transfer apparatus in the processes for manufacturing wafer solder bumps. The wafer transfer apparatus connects at least one wafer cassette, a flux dispenser device, a ball placement device, an inspection device and a reflow oven device and transfers a wafer therebetween. The apparatus also connects the at least one wafer cassette, a bump printing device, an inspection device and a reflow oven device, and transfers a wafer therebetween. The method for transferring a wafer includes the steps of picking up a wafer, transferring the wafer, and unloading the wafer. Therefore, after the wafer is unloaded from the wafer cassette, the robot arm may transfer the wafer to/from each processing unit, and it is not necessary to repeatedly load/unload the wafer from the wafer cassette. Accordingly, it is possible to reduce the processing time, increase the throughput, simplify the steps of transferring the wafer, lower the possibility of breaking wafer, and saving the space and the apparatus.

When the wafer is inspected as a bad one that cannot be reworked, the wafer transfer apparatus transfers the wafer back to the wafer cassette. When the wafer is inspected as a bad one that can be reworked, the wafer transfer apparatus transfers the wafer back to the ball placement/bump printing unit when the ball placement/bump printing unit is at a standby mode. Then, the wafer is reworked for ball placement/bump printing.

### BRIEF DESCRIPTION OF THE DRAWINGS

FIG. 1A is a schematic illustration showing a conventional wafer ball placement apparatus.

FIG. 1B is a schematic illustration showing a conventional wafer bump printing apparatus.

FIG. 2 is a schematic illustration showing a wafer transfer apparatus according to a first embodiment of the invention.

FIG. 3 is a schematic illustration showing a wafer transfer apparatus according to a second embodiment of the invention.

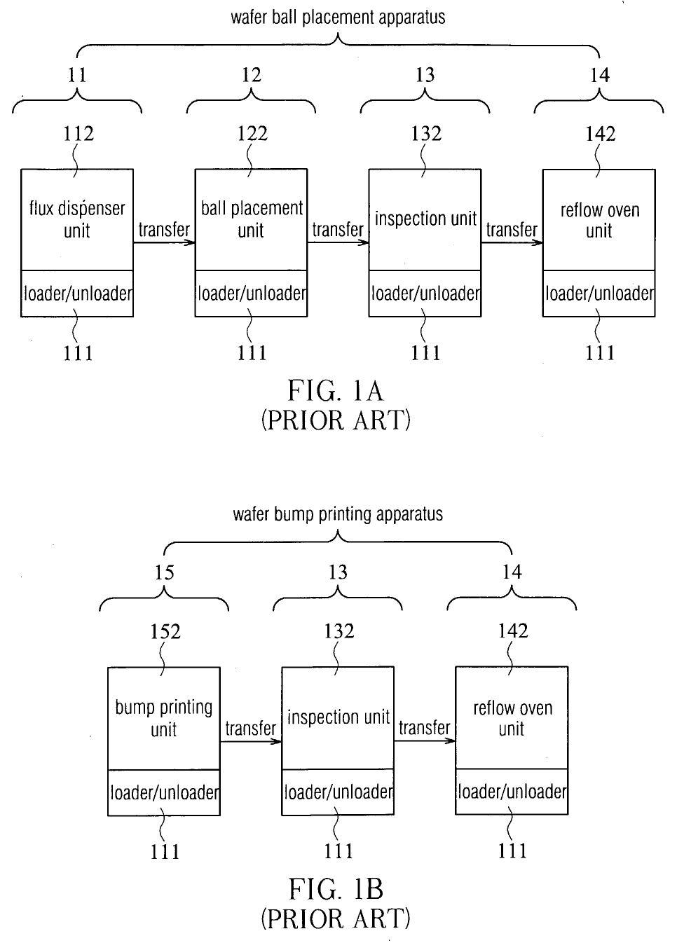

### DETAILED DESCRIPTION OF THE INVENTION

1. First Embodiment

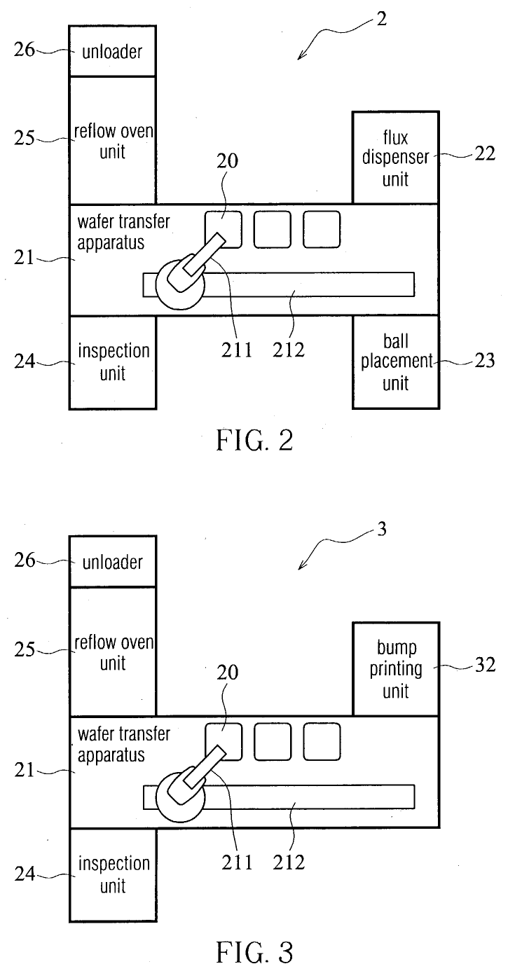

Please refer to FIG. 2, which shows a wafer transfer apparatus according to a first embodiment of the invention. As shown in FIG. 2, a wafer transfer apparatus 21 is adapted to a wafer ball placement apparatus 2, which includes at least one wafer cassette 20, a flux dispenser unit 22, a ball placement unit 23, an inspection unit 24, a reflow oven unit 25, and an unloader 26. The wafer transfer apparatus 21 includes a robot arm 211 and a stage 212.

The at least one wafer cassette 20 carries a wafer or a plurality of wafers. The at least one wafer cassette 20 is loaded into the wafer transfer apparatus 21. The robot arm 211 of the wafer transfer apparatus 21 picks up a wafer from the at least one wafer cassette 20 and transfers the wafer to the flux dispenser unit 22. After the flux dispenser unit 22 applies flux to the wafer, the robot arm 211 further transfers the wafer to the ball placement unit 23. After the ball placement unit 23 places tin balls on the wafer, the robot arm 211 transfers the wafer to the inspection unit 24. When the inspection unit 24 judges the wafer as a good one, the robot arm 211 transfers the wafer to the reflow oven unit 25, in which the wafer is reflowed. After the wafer is reflowed, the unloader 26 unloads the wafer. When the wafer is judged as a bad one that cannot be reworked, the robot arm 211 transfers the bad wafer back to the at least one wafer cassette 20. When the wafer is judged as a bad one that can be reworked, the robot arm 211 transfers the wafer back to the at least one wafer cassette 20. After the ball placement unit 23 is at a standby mode, the wafer is again transferred to the ball placement unit 23 for ball placement.

Because the robot arm 211 of the wafer transfer apparatus 21 has to move over a large area, the robot arm 211 is carried on the stage 212 so that the robot arm 211 may be moved over the wafer transfer apparatus 21.

2. Second Embodiment

Please refer to FIG. 3, which shows a wafer transfer apparatus according to a second embodiment of the invention. As shown in FIG. 3, the wafer transfer apparatus 21 is adapted to a wafer ball placement apparatus 3, which includes at least one wafer cassette 20, a bump printing unit 32, an inspection unit 24, a reflow oven unit 25, and a unloader 26. The wafer transfer apparatus 21 includes a robot arm 211 and a stage 212.

The at least one wafer cassette 20 carries a wafer or a plurality of wafers. The at least one wafer cassette 20 is loaded into the wafer transfer apparatus 21. The robot arm 211 of the wafer transfer apparatus 21 picks up a wafer from the at least one wafer cassette 20 and transfers the wafer to the bump printing unit 32. After the bump printing unit 32 prints solder paste on the wafer, the robot arm 211 transfers the wafer to the inspection unit 24. When the inspection unit 24 judges the wafer as a good one, the robot arm 211 transfers the wafer to the reflow oven unit 25. After the reflow oven unit 25 reflows the wafer, the unloader 26 unloads the wafer. When the wafer is judged as a bad one that cannot be reworked, the robot arm 211 transfers the wafer back to the at least one wafer cassette 20. When the wafer is judged as a bad one that can be reworked, the robot arm 211 transfers the wafer back to the at least one wafer cassette 20. After the bump printing unit 32 is at a standby mode, the wafer is transferred to the bump printing unit 32, in which the wafer is printed again.

Because the robot arm 211 of the wafer transfer apparatus 21 has to move over a large area, the robot arm 211 is carried on the stage 212 so that the robot arm 211 may be moved over the wafer transfer apparatus 21. On the other hand, when the robot arm 211 does not have to move over the large area, it is also possible to remove the stage 212. In this case, only the robot arm 211 is utilized to transfer the wafer between the devices.

To sum up, because the wafer transfer apparatus is utilized to connect the processing devices, after the wafer is unloaded from a wafer cassette, the robot arm may continuously transfer the wafer between the processing devices without repeatedly loading the wafer into the cassette and unloading the wafer out of the cassette. Hence, the wafer may be processed continuously, the steps for transferring the wafer may be simplified, the possibility of wafer breaking may be decreased, the processing time may be shortened, the production efficiency may be improved, and the space and apparatus may be saved.

What is claimed is:

1. A wafer transfer apparatus (21) adapted to a wafer ball placement apparatus (2), which comprises at least one wafer cassette (20), a flux dispenser unit (22), a ball placement unit (23), a reflow oven unit (25), and an unloader (26), the apparatus (21) comprising:
a robot arm (211) for picking up a wafer from the at least one wafer cassette (20) and transferring the wafer to/from one of the at least one wafer cassette (20), the flux dispenser unit (22), the ball placement unit (23) and the reflow oven unit (25); and
a stage (212) for carrying the robot arm (211) so that the robot arm (211) is moved thereon.

2. The wafer transfer apparatus (21) according to claim 1, wherein the ball placement unit (23) further comprises an inspection unit (24), and the robot arm (211) transfers the wafer to/from the inspection unit (24).

3. A wafer transfer apparatus (21) adapted to a wafer bump printing apparatus (3), which comprises at least one wafer cassette (20), a bump printing unit (32), a reflow oven unit (25) and an unloader (26), the apparatus (21) comprising:
a robot arm (211) for picking up a wafer from the at least one wafer cassette (20) and transferring the wafer to/from one of the at least one wafer cassette (20), the bump printing unit (32), and the reflow oven unit (25).

4. The wafer transfer apparatus (21) according to claim 3, wherein the wafer bump printing apparatus (3) further comprises an inspection unit (24) and the robot arm (211) transfers the wafer to/from the inspection unit (24).

5. The wafer transfer apparatus (21) according to claim 3, wherein the wafer transfer apparatus (21) further comprises a stage (212) for carrying the robot arm (211) so that the robot arm (211) is moved thereon.

6. A wafer ball placement apparatus (2), comprising:
at least one wafer cassette (20) for carrying wafers;
a wafer transfer apparatus (21) for transferring a wafer;
a flux dispenser unit (22) for receiving the wafer transferred by the wafer transfer apparatus (21) and applying flux to the wafer;
a ball placement unit (23) for receiving the wafer transferred by the wafer transfer apparatus (21) and placing a plurality of tin balls on the wafer applied with the flux;
a reflow oven unit (25) for receiving the wafer transferred by the wafer transfer apparatus (21) and heating and reflowing the plurality of tin balls on the wafer that has passed an inspection; and
an unloader (26) for receiving the wafer from the reflow oven unit (25) and unloading the wafer from the wafer ball placement apparatus (2), wherein the wafer transfer apparatus (21) comprises:
a robot arm (211) for picking up the wafer from the at least one wafer cassette (20) and transferring the wafer to/from one of the at least one wafer cassette (20), the flux dispenser unit (22), the ball placement unit (23), the inspection unit (24), and the reflow oven unit (25); and
a stage (212) for carrying the robot arm (211) so that the robot arm (211) is moved thereon.

7. The wafer ball placement apparatus (2) according to claim 6, further comprising an inspection unit (24) for receiving the wafer transferred by the wafer transfer apparatus (21) and inspecting the plurality of tin balls placed on the wafer.

8. A wafer bump printing apparatus (3), comprising:
at least one wafer cassette (20) for carrying wafers;
a wafer transfer apparatus (21) for transferring a wafer;
a bump printing unit (32) for receiving the wafer transferred by the wafer transfer apparatus (21) and printing solder paste on the wafer;
a reflow oven unit (25) for receiving the wafer transferred by the wafer transfer apparatus (21) and heating and reflowing the wafer printed with the solder paste; and
an unloader (26) for receiving the wafer from the reflow oven unit (25) and unloading the wafer from the wafer bump printing apparatus (3), wherein the wafer transfer apparatus (21) comprises:
a robot arm (211) for picking up the wafer from the at least one wafer cassette (20) and transferring the wafer to/from one of the at least one wafer cassette (20), the bump printing unit (32), the inspection unit (24), and the reflow oven unit (25).

9. The wafer bump printing apparatus (3) according to claim 8, further comprising an inspection unit (24) for receiving the wafer transferred by the wafer transfer apparatus (21) and inspecting the solder paste printed on the wafer.

10. The wafer bump printing apparatus (3) according to claim 8, wherein the wafer transfer apparatus (21) further comprises a stage (212) for carrying the robot arm (211) so that the robot arm (211) is moved thereon.

11. A method for transferring a wafer, the method being adapted to a wafer ball placement apparatus (2), which comprises at least one wafer cassette (20), a wafer transfer apparatus (21), a flux dispenser unit (22), a ball placement unit (23), an inspection unit (24), a reflow oven unit (25), and an unloader (26), and the method comprising the steps of:
picking up the wafer from the at least one wafer cassette (20) by the wafer transfer apparatus (21);
transferring the wafer to/from one of the at least one wafer cassette (20), the flux dispenser unit (22), the ball placement unit (23), the inspection unit (24), and the reflow oven unit (25) by the wafer transfer apparatus (21); and
unloading the wafer by the unloader (26).

12. A method for transferring a wafer, the method being adapted to a wafer bump printing apparatus (3), which comprises at least one wafer cassette (20), a wafer transfer apparatus (21), a bump printing unit (32), an inspection unit (24), a reflow oven unit (25), and an unloader (26), and the method comprising the steps of:
picking up the wafer from the at least one wafer cassette (20) by the wafer transfer apparatus (21);
transferring the wafer to/from one of the at least one wafer cassette (20), the bump printing unit (32), the inspection unit (24), and the reflow oven unit (25) by the wafer transfer apparatus (21); and
unloading the wafer by the unloader (26).
